(19) United States
(12) Patent Application Publication
(10) Pub. No.: US 2004/0193525 A1
(43) Pub. Date: Sep. 30, 2004

(54) Online bidding system and method of the same

(76) Inventor: Min-Chi Huang, Taoyuan (TW)

Correspondence Address: HARNESS, DICKEY & PIERCE, P.L.C., P.O. BOX 8910, RESTON, VA, 20195, US

(21) Appl. No.: 10/397,276

(22) Filed: Mar. 27, 2003

(51) Int. Cl. G06F 17/60; G06F 7/00; G06F 17/00

(52) U.S. Cl. 705/37; 707/100

(57) ABSTRACT

This specification discloses an online bidding system and the method thereof. During the bidding process, the left bidding time of a case is used to define different statistical analysis weights. Combined the trade data of the deals done in the past with the seller of the current case, the system searches for match conditions and bidding information of the bidders. It actively performs real-time statistical analysis for possible match chances of the current case. Such information is provided to the bidders in the bidding process for their reference to make further bids. Therefore, the disclosed system and method can increase the chances of matching between the seller and the bidders. The invention utilizes a weighted statistical analysis method to provide bidders with valuable bidding strategies during the bidding process, so that the bidders can possibly win the bid at a lower cost.

### BACKGROUND OF THE INVENTION

1. Field of Invention

The invention relates to a data processing system and method that helps case matching in e-Marketplace. In particular, it relates to a system that actively provides matching assistance during an online bidding process of a project.

2. Related Art

With the rise of the Internet, there are an increasing number of people performing commercial activities on line. In order to complete a transaction, people usually have to exchange and/or extract data through the Internet. As the Internet has become ubiquitous, people have fewer intersections on the network. This of course results in some difficulty for people to have business-related activities.

In order to centralize all related business activities at one place and to integrate relevant information, the e-Marketplace based upon the Internet platform and operating via auction processes has emerged. Some famous e-Marketplaces include eBay (www.ebay.com) and Yahoo (auctions.shopping.yahoo.com). Although such e-Markets show complete information of sellers, bidders and auctions, offer functions for sellers to post cases, and provide various bidding methods (such as Buy It Now, Auto Bidding, etc) for bidders to select, these websites often allow very little interactions between the sellers and the bidders. Therefore, these websites usually can provide thorough integration of information, but lack of a perfect mechanism for aiding the match between bidders and sellers.

In other words, the common e-Marketplace simply plays the role of a platform for sellers and bidders to trade in the online commercial activities. It simply performs the trade managements without actively helping case matches. This results in very few interactions among sellers, bidders and the e-Marketplace. Sellers and bidders cannot find an optimal pricing strategy through the help of the e-Marketplace. During the bidding process, sellers and bidders can merely wait and see the auction proceeds. There is no way for them to actively seek the opportunity to match for the case. It turns out that sellers, bidders and the e-Marketplace all lose in this situation.

Therefore, how to establish an e-Marketplace on the Internet that can actively provide matching assistance and matching chances so that online commercial activities can be more vivid is an important subject that should be studied by people skilled in the art.

### SUMMARY OF THE INVENTION

In view of the foregoing problems existing in the prior art, we think providing a matching assistance mechanism that shows in real time bidding time and bidding prices during the bidding process is the direction of future e-Marketplaces. Thus, the invention proposes a bidding system and the associated method that helps price matching. During the bidding process, the left time ratio of a case is sued to set different statistical analysis weights. It further combines the trade history in the past with the match conditions set by the seller of the current case and the bidding information from bidders to actively seek the opportunity to match for the case in real time. Such information is provided to the bidders for making bids. Therefore, it can increase the chances for case matching.

The invention mainly utilizes a weighted statistical analysis. During different stages of the bidding process (i.e. different left time ratios), a weight table is used to provide different weights for computation. Valuable bidding strategies are generated (including possible match prices, matching probabilities, etc) for bidders to adjust their bids. This makes bidders more willing to win the case at a lower price, effectively increasing the chances for case matching.

On the other hand, sellers can provide trade histories of particular case information (such as case types, case descriptions, etc) as a reference to set the starting price.

Through the matching assistance mechanism offered by the invention, sellers and bidders can obtain more real-time information through interactions with the disclosed system. This greatly increases the matching chances of commissioned cases, achieving the win-win goal among sellers and bidders. For the e-Marketplace managers, the invention increases not only users' will to trade but also the reputation and profits of the website.

### BRIEF DESCRIPTION OF THE DRAWINGS

The invention will become more fully understood from the detailed description given hereinbelow illustration only, and thus are not limitative of the present invention, and wherein:

FIG. 1 is a schematic view of the operation of the disclosed online bidding system and method;

FIG. 2 is a block diagram of the disclosed online bidding system and method;

FIG. 3A is a flowchart of the invention;

FIG. 3B is a bidding flowchart of the invention;

FIG. 3C is a matching flowchart of the invention;

FIG. 3D is a setup flowchart of the invention;

FIG. 4A is a schematic view of a case posting screen according to the invention;

FIG. 4B is a schematic view of a match setting screen according to the invention;

FIG. 4C is a schematic view of a case browsing screen according to the invention; and

FIG. 4D is a schematic view of a bid information input screen according to the invention.

### DETAILED DESCRIPTION OF THE INVENTION

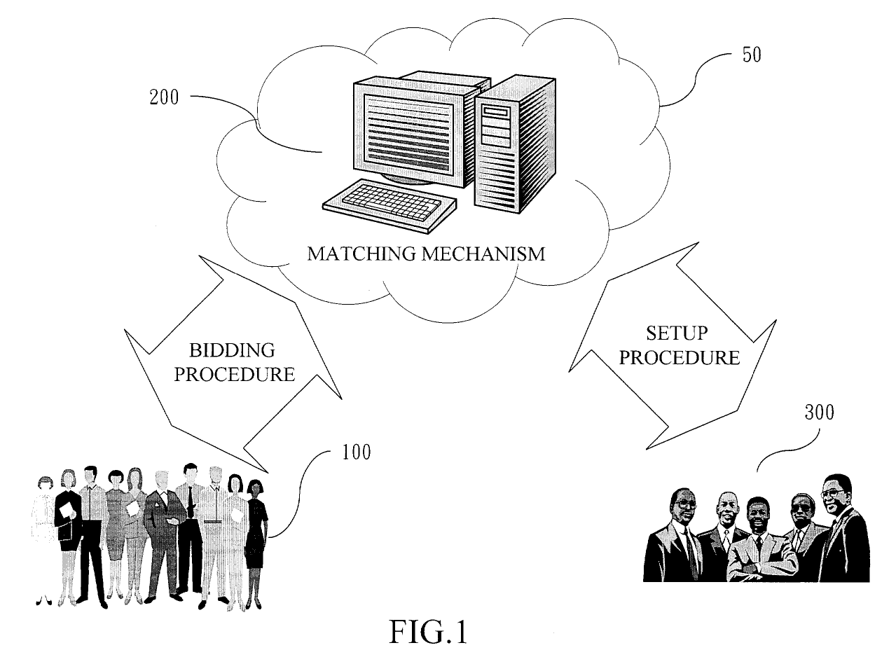

The invention relates to an e-Marketplace system and the associated method that actively provide matching assistance during bidding processes. As shown in FIG. 1, a bid assistance system 200 on the Internet 50 is established to provide a matching mechanism for a seller 300 and bidders 100. The bidders 100 can obtain information about possible matching chances through the statistical analysis by the bid assistance system 200. The seller 300 can also obtain information about trade histories of related cases when setting up the starting price. Such a mechanism can greatly increase the opportunities for matching cases.

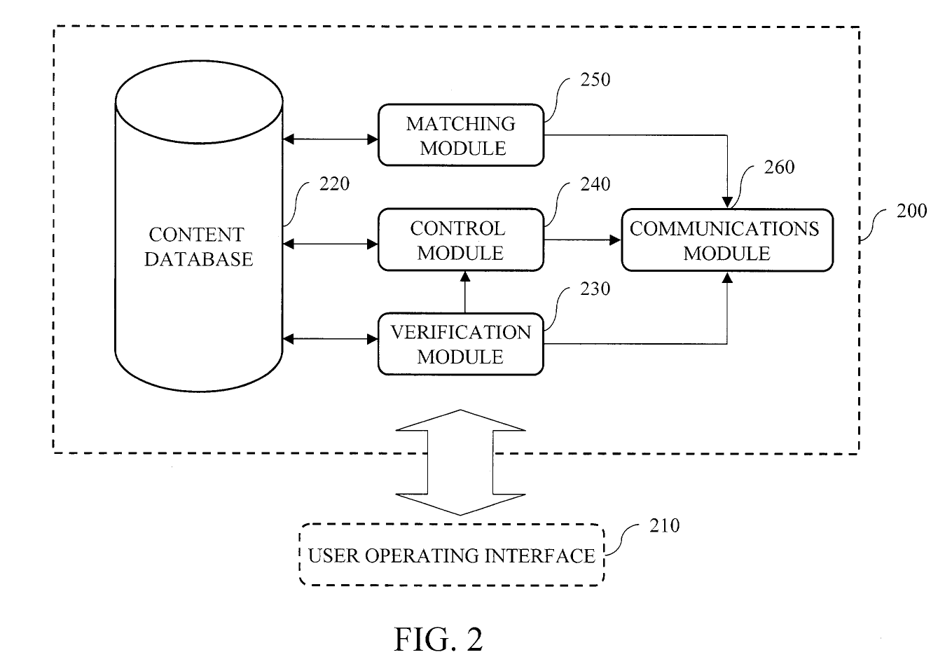

We use FIG. 2 to explain the functional modules of the bid assistance system 200:

(1) The content database 220 is mainly used to store user data, including the username, the corresponding password, basic information, and user's credit evaluation. The user's credit evaluation is generated by the matching module 250 after each case is closed. The rest data are entered by the user during registration at the disclosed matching assistance system 200. The seller 300 provides case information (such as the case type, case name, case description, case time, case location, etc), matching conditions (such as matching assistance time, highest payment price, buy-it-now price, credit evaluation minimum, etc). It also stores the bidding information (such as the current bid and the bid-winning price) entered by the bidders 100 during the auction, the history of past deals and bids.

The case type and case description in the case information are mainly used for bidders' convenience to search and select cases. The disclosed bid assistance system 200 also uses the strings in the case type and case description to search for the history of deals, so that the records of related cases can be rapidly found in the auction setup and the matching process. The seller 300 can browse through the information and perform weighted analyses.

The matching assistance time is set by the seller 300 to tell the bid assistance system 200 when matching assistance is required for the case. The highest payment price is the price that the seller 300 is willing to pay and also the initial price of the auction. The buy-it-now price is the lowest price the seller asks for. When the bidders 100 matches the buy-it-now price, it means that the case is successfully done and the matching process is over. The required credit evaluation is the trust indicator required by the seller 300. It is the minimum credit threshold that a bidder has to have. Only those who have higher credit evaluations can participate in the auction.

The current bid is the actual bid the bidder 100 has in each auction. The bid-winning price is the least price that the bidder 100 sets to get. If this price matches with the buy-it-now price set by the seller 300, the case is successfully matched and closed.

(2) The verification module 230 verifies the user's login action. The verification is done by extracting user's data stored in the content database 220. The username and password are used to check whether the user is allowed to login.

(3) The control module generates various screens to receive information entered by the user in the setup procedure and the bidding procedure. Such actions include: receiving case information settings in the case posting screen, receiving matching condition settings in the match setting screen, and receiving bidding information setting in the case browsing screen.

(4) The matching module 250 analyses the case information set by the seller 300. It determines the case type, searches and extracts the histories of related cases in the content database 220. Along with the bidding information of the bidders 100 and the matching conditions set by the seller 300, the module performs weighted analyses.

The matching module 250 has a timing unit to measure the rest time of an auction. When the rest time satisfies the matching assistance time set by the seller 300, the system enters the active matching procedure to perform the weighted analysis. The weighted analysis refers to the analysis that selects a weight value according to the rest time ratio (left bidding time/whole bidding time) from a weight table provided by the disclosed matching module 250. This weight is then used to compute a matching probability and a possible matching price according to the deal history.

(5) The communications module 260 receives the execution results of the verification module 230, the control module 240, and the matching module 250. It also sends information and suggestions, such as the login failure message (in the verification procedure), the unqualified message (when the price bid by the bidder 100 does not satisfy the minimum criteria or the credit evaluation of the bidder 100 is not high enough), the information deficiency message (when the case information entered by the seller 300 is insufficient), the incompleteness message (when the matching information set by the seller 300 is incomplete), the case matching message (when the matching procedure is successful), and the matching analysis message (to show the weighted analysis result). The transmission of messages and suggestions can be performed via web pages, E-mail or pop-up message windows.

In fact, the communications and interactions between the disclosed bid assistance system 200 and the user (including the bidders 100 and the seller 300) are conducted through a user operating interface 210. Such an interface is used to display various operation and control screens, such as the case posting screen, the match setting screen, the case browsing screen, etc. It enables the seller 300 and the bidders 100 to interact during the setup and bidding processes.

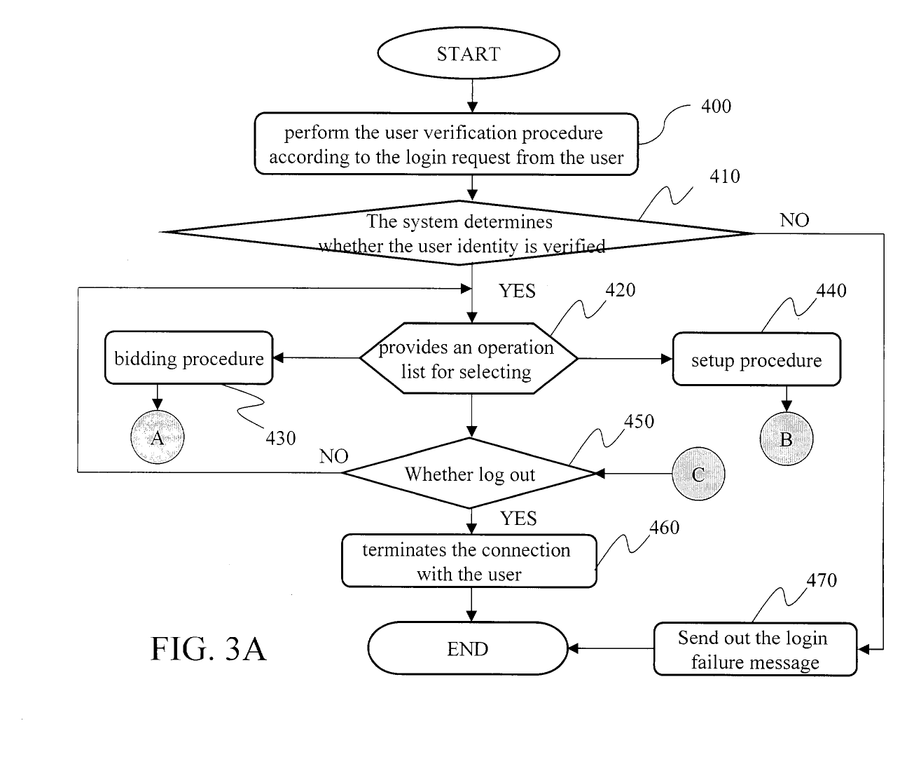

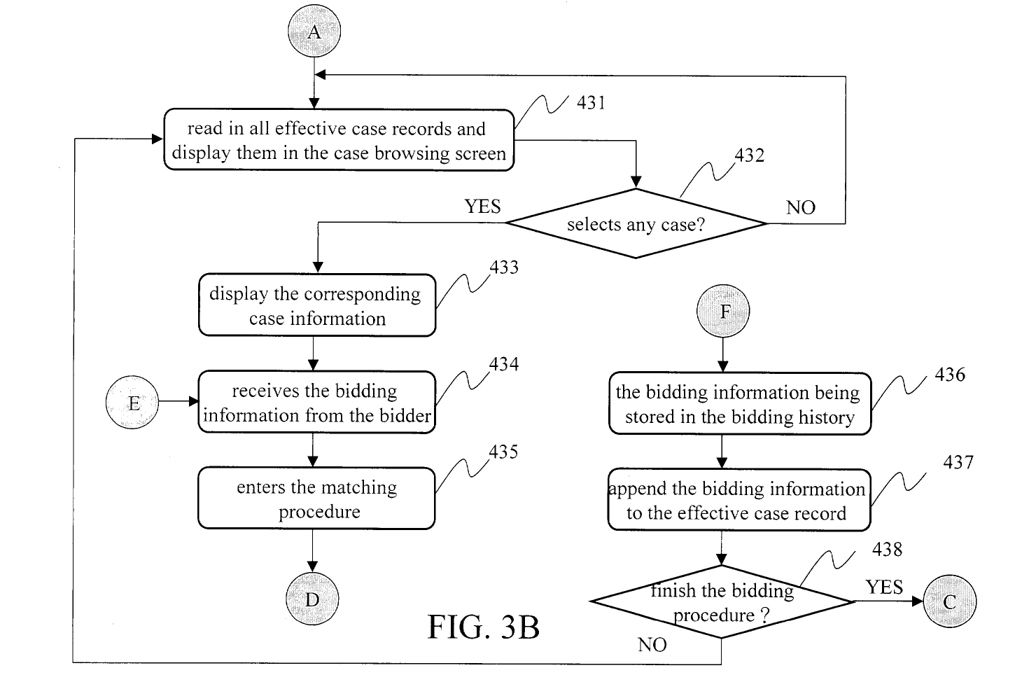

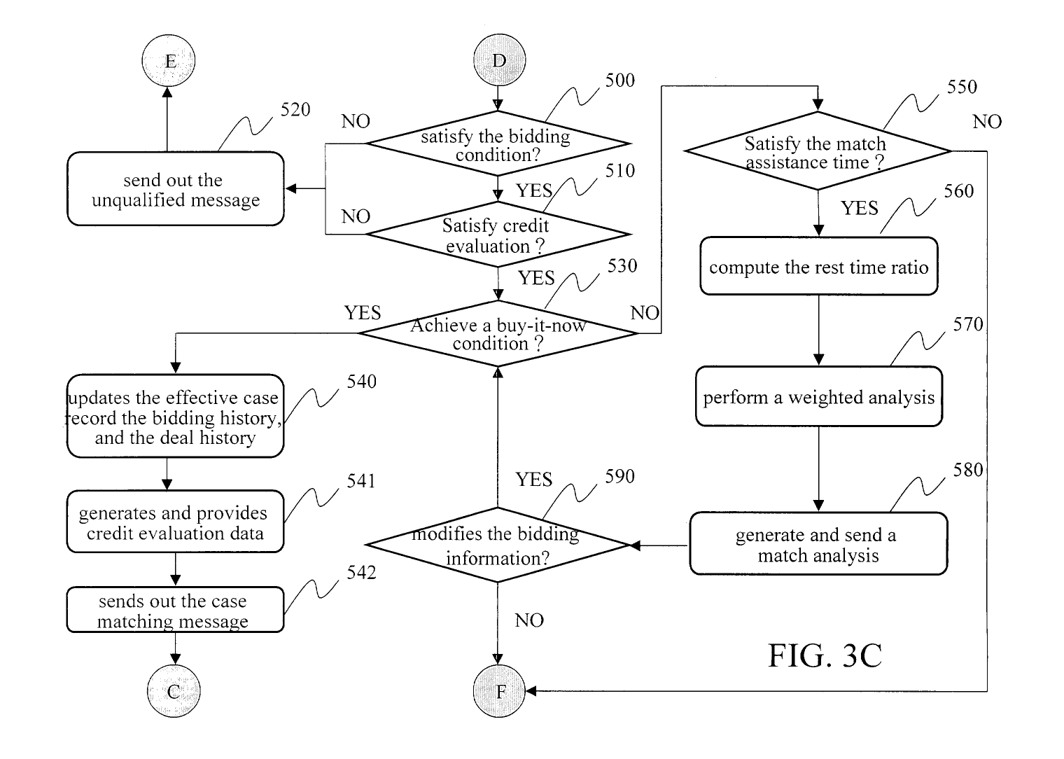

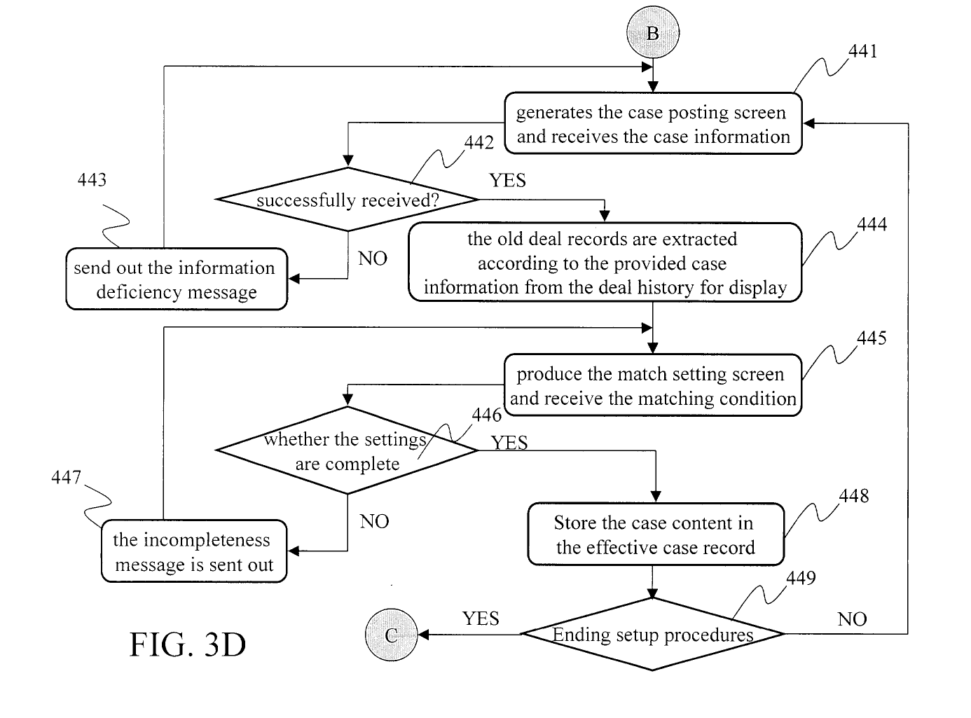

The main procedure of setting up an auction and bidding can be explained with reference to FIG. 3A. First, the disclosed bid assistance system 200 performs the user verification procedure according to the login request from the user (step 400). The user verification procedure is done using the username and password. The system determines whether the user identity is verified (step 410). If the user does not pass the verification, the communications module 260 sends out the login failure message to the user (step 470) and finishes the procedure. If the user passes the verification, the system provides an operation list for the user to select (step 420). The user can choose the bidding procedure (step 430) or the setup procedure (step 440). Once the user finishes a particular operation, the system goes back to the main procedure. At the moment, the bid assistance system 200 checks whether the user wants to log out (step 450). If not, the system returns to step 420 and provides operation selections. Otherwise, if the user wants to log out, the system terminates the connection with the user (step 460) and finishes the main procedure.

When the user selects the bidding procedure (step 430), the procedure enters step A (see FIG. 3B). The control module 240 reads in all effective case records from the content database 220 and displays them in the case browsing screen (step 431). The effective cases refer to the cases that are still available for bidding (i.e. those that have not expired yet). The system determines whether the bidder 100 selects any case (step 432). If not, the system waits at step 431. If a case is selected, the system displays the corresponding case information (step 433) and waits for the bidder 100 to enter bidding information. The system then receives the bidding information from the bidder 100 (step 434). Afterwards, the system enters the matching procedure in step D (step 435). This part will be explained later with reference to FIG. 3C. If the matching procedure is not successful, the system returns to the main procedure through step F, the bidding information entered by the bidder 100 being stored in the bidding history (step 436). The bidding information is also appended to the effective case record (step 437) for the reference of future bidders 100. The system further determines whether the bidder 100 has finished the bidding procedure (step 438). If not, the system returns to step 431; otherwise, it enters step C and returns to step 450 in the main procedure.

With reference to FIG. 3C, after entering the matching procedure through step D (step 435), the system first determines whether the bidding information satisfies the bidding condition (step 500). The bidding condition is the minimum increment of a bid from the previous one set by the bid assistance system 200 that the bidder 100 has to comply with. If a bid does not satisfy the bidding condition, the system sends out the unqualified message via the communications module 260 (step 520). The system returns via step E to step 434 for the bidder 100 to make a new bid. Once the bid satisfies the bidding condition, the bidder 100 is checked to see whether his or her credit evaluation is good enough (step 510). If not, the communications module 260 sends out the unqualified message (step 520), and the system returns to step 434 via step E for the bidder 100 to make other bids. If the bidder 100 satisfies the credit evaluation minimum, the current bid price of the bidder 100 is compared with the buy-it-now price set by the seller 300 (step 530). If it reaches the but-it-now price, then the system updates the effective case record (by removing the current case from the list), the bidding history, and the deal history (by appending the bidding history and deal history of the current case to the record) (step 540). The matching module 250 generates and provides credit evaluation data for the bidder 100 (step 541). The credit evaluation data are automatically generated whenever a case is successfully matched and are added to the user credit evaluation data of the bidder 100. The system then sends out the case matching message to the bidder 100 and the seller 300 via the communication module 260 (step 542). The procedure finally goes to step 450 via step C.

At step 530, if the current bid price offered by the bidder 100 does not reach the buy-it-now price, the matching module 250 determines whether the match assistance time set by the seller 300 is up (step 550). If not, then the current matching procedure is not successful, and the system goes back to step 436 via step F. If the match assistance time is reached, the system computes the rest time ratio (step 560). It further analyzes case information (determining case type) and finds all related records from the deal history according to the case type. The system performs a weighted analysis by combining the above information with the bid information (the current bid price) of the bidder 100 and the matching condition (the buy-it-now price) set by the seller 300 (step 570). The weighted analysis utilizes the weight table provided by the matching module 250 to find the weight corresponding to the current rest bidding time ratio. The weight is then used to analyze a matching probability and a possible matching price according to the old deal history given the left bidding time. Finally, a matching analysis is generated and provided for the bidder's reference (step 580). The system determines whether the bidder 100 modifies the bidding information (step 590). If so, the system goes to step 530 for determining whether the adjusted bid matches with the buy-it-now price. If the bidder 100 maintains the original bid, then the current matching procedure is unsuccessful and the system returns to step 436 via step F.

Moreover, the invention further provides the user to select the setup procedure (step 440) in the main procedure. From step B in FIG. 3A, the system can enter the setup procedure (see FIG. 3D). When the seller 300 enters the setup procedure, the control module 240 generates the case posting, screen and receives the case information entered by the seller 300 (step 441). If information is not successfully received (step 442), the communications will send out the information deficiency message (step 443) and the system goes back to step 441. Once the case information is successfully received, the old deal records are extracted according to the provided case information from the deal history for display (step 444). Such information provides the reference for the seller 300 to set the matching condition. Afterwards, the system produces the match setting screen and receives the matching condition from the seller 300 (step 445). The system also determines whether the settings are complete (step 446). If not, the incompleteness message is sent out (step 447), and the system returns to step 445 for setting the matching condition. If the matching condition is successfully received, the case contents (including the case information and matching information) are recorded in the effective case record (step 448). Such information is provided for the bidders 100 to browse. Finally, the system determines whether the seller wants to finish the setup procedure. If not, the system goes back to step 441 for the seller to perform other operations; otherwise, the system returns to step 450 in the main procedure via step C.

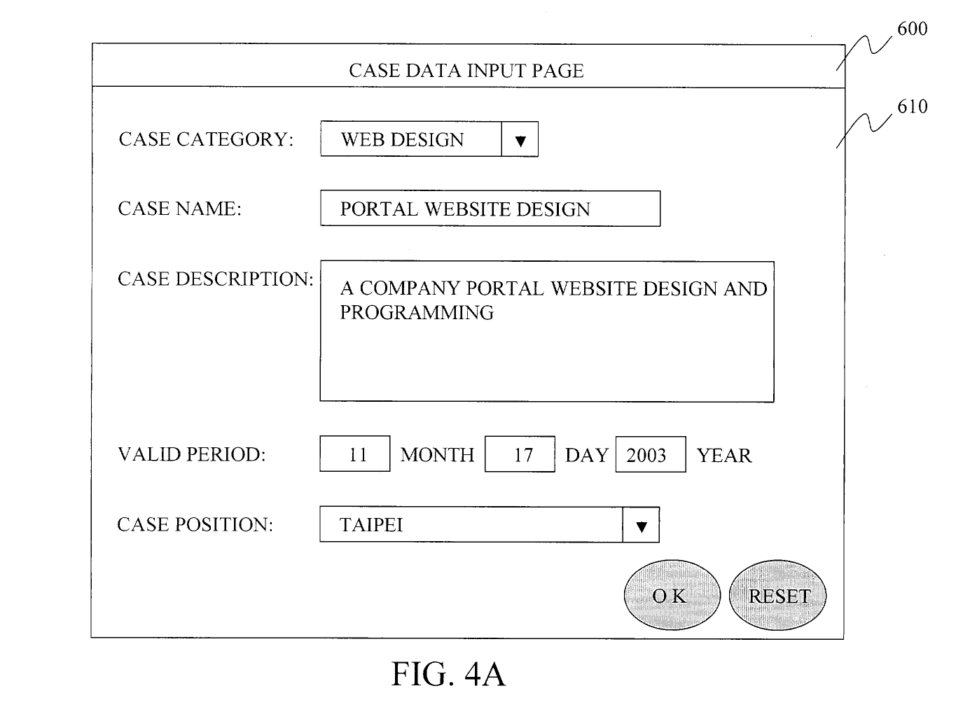

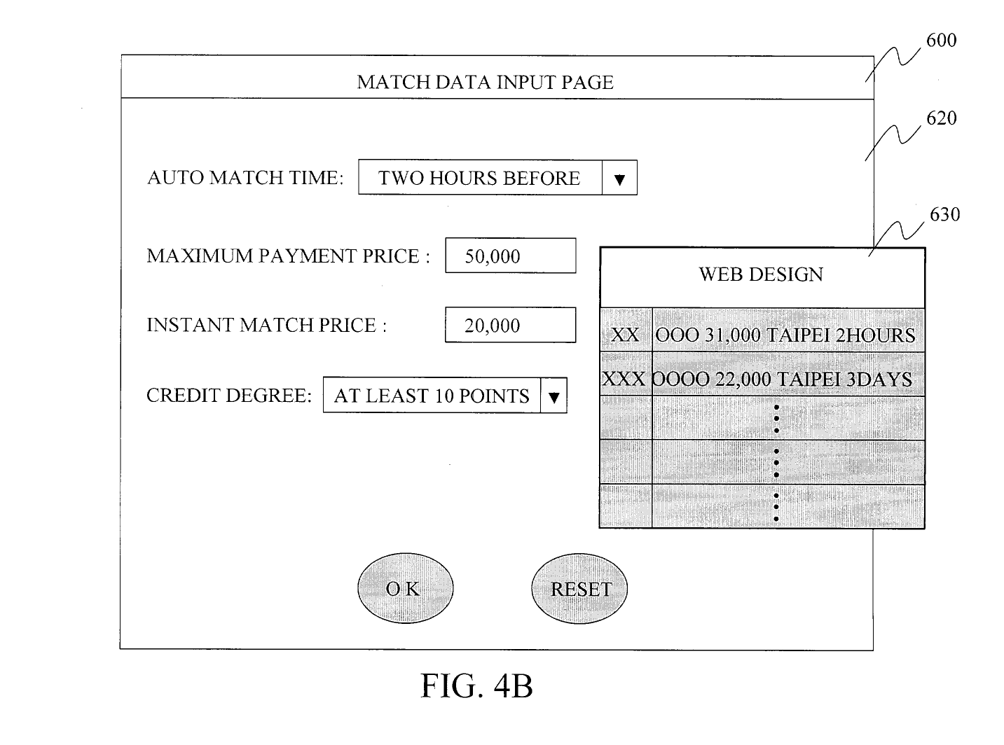

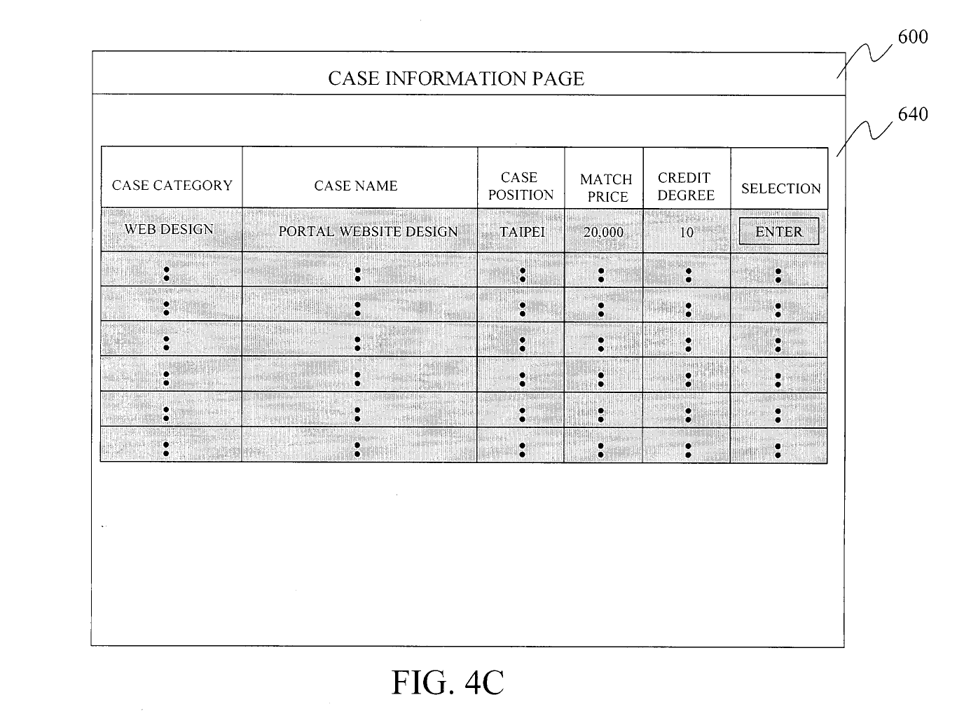

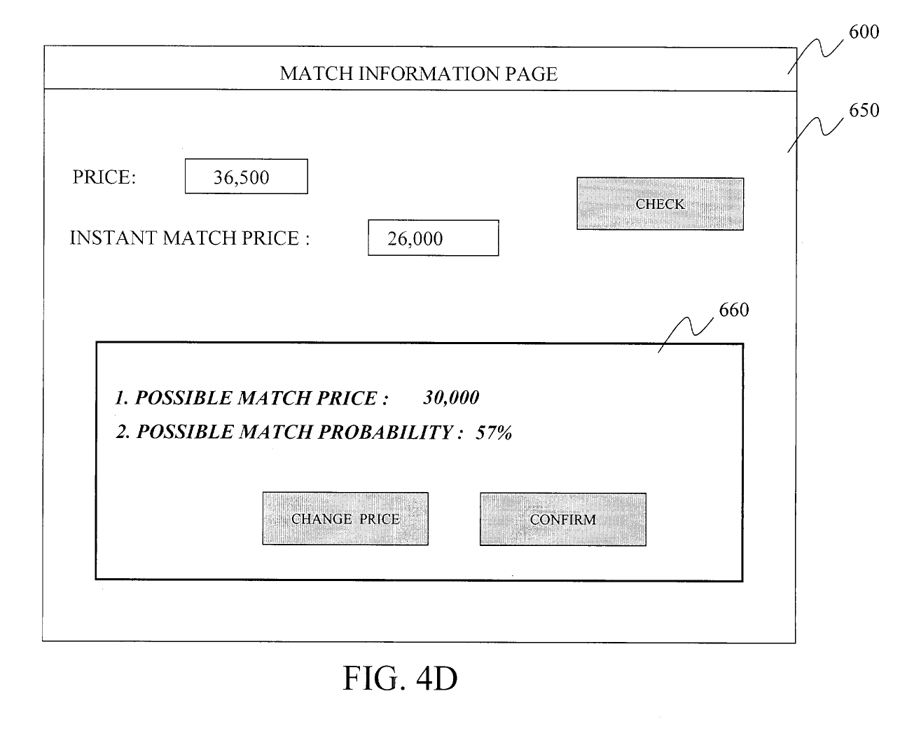

FIGS. 4A through 4D detail the implementation of the invention. The bidder 100 and the seller 300 perform various bidding and setup procedures using a browser 600. In the setup procedure, the seller 300 enters various case information through the provided case posting screen 610 (see FIG. 4A) and the matching condition of the case through the match setting screen 620. When setting the match condition, the seller 300 can refer in real time to the deal history screen 630 (FIG. 4B) provided by the disclosed bid assistance system 200. During the bidding procedure, the bidder 100 can ask the bid assistance system 200 to first select the effective case records for generating the case browsing screen (FIG. 4C). Once entering the price information input screen 650 of the selected cases, the bidder 100 can begin to bid. After the bidding, the bid assistance system 200 automatically determines whether the bid is high enough. If there is no match and the match assistance time is reached, the bid assistance system 200 further generates the match analysis screen 660, providing a possible matching price and a matching probability to the bidder 100 for him or her to determine whether to adjust the bid (FIG. 4D). If the bid is modified, the matching process keeps going as described until a successful match. The above mechanism can effectively increase the matching chance of a case.

Certain variations would be apparent to those skilled in the art, which variations are considered within the spirit and scope of the claimed invention.

What is claimed is:

1. An online bidding system with match assistance to perform statistical analyses of a matching probability according to trade history data with the help of a statistical weight determined by a rest bidding time ratio for a bidder to determine whether to adjust his/her bid, thereby enhancing the matching chance between a seller and a bidder, the system comprising:
a content database, which stores user data, case information and a matching condition set by the seller, bid information entered by the bidder, deal history records from the past, and a bid history;
a verification module, which extracts user information when a user logs onto the system to verify the user's identity;
a control module, which receives operations performed by the user in a setup procedure and/or a bidding procedure after verifying the user's identity;
a matching module, which analyzes the case information and extracts information from the deal history records, the bidding information and the matching condition to perform a weighted analysis; and
a communications module, which receives the execution results of the verification module, the control module, and the matching module, and sends out messages and suggestions;
wherein each of the modules interacts with the seller and the bidder via a user operating interface during the setup procedure and the bidding procedure.

2. The system of claim 1, wherein the user information includes at least a username, a password, user's basic data, and a credit evaluation of the user.

3. The system of claim 1, wherein the case information includes at least a case type, a case name, a case description, a case time, and a case location.

4. The system of claim 1, wherein the matching condition includes at least a match assistance time, a highest payment price, a buy-it-now price, and a minimum credit evaluation.

5. The system of claim 1, wherein the bidding information includes at least a current bid price and a bid-winning price.

6. The system of claim 1, wherein the matching module includes at least a timing unit for measuring the time.

7. The system of claim 1, wherein the matching module includes at least a weight table for obtaining a weight according to the rest bidding time ratio.

8. The system of claim 1, wherein the communications module sends out messages and suggestions via a means selected from the group consisting of a web page, an E-mail message, and a pop-up message window.

9. An online bidding method with match assistance to perform statistical analyses of a matching probability according to trade history data with the help of a statistical weight determined by a rest bidding time ratio for a bidder to determine whether to adjust his/her bid, thereby enhancing the matching chance between a seller and a bidder, the method comprising the steps of:
executing a user verification procedure according to a login request;
selecting to execute a bidding procedure and performing the operations of a matching procedure; and
accepting logout and terminating the connection.

10. The method of claim 9, wherein the step of executing a user verification procedure according to a login request is done using a username and a user password.

11. The method of claim 10, wherein the step of executing a user verification procedure according to a login request further includes the step of sending out a login failure message when the user does not pass the verification.

12. The method of claim 9, wherein the step of selecting to execute a bidding procedure and performing the operations of a matching procedure further comprises the steps of:
reading effective case records and displaying them on a case browsing screen;
receiving a selection from the bidder;
display the corresponding case information;
receiving bidding information entered by the bidder; and
entering the matching procedure.

13. The method of claim 12, wherein the effective case records refer to all available cases that have not expired.

14. The method of claim 12, wherein the step of entering the matching procedure comprises the steps of:
satisfying a bidding condition;
satisfying a required credit evaluation;
satisfying a match assistance time;
computing a rest bidding time ratio;
analyzing the case information and extracting the deal history records along with
the bidding information and the matching condition to perform a weighted analysis;
generating a match analysis and sending it out; and
adjusting the bidding information, completing the matching and finishing the matching procedure.

15. The method of claim 14, wherein the bidding condition is a predetermined minimum bid increment that the bidder has to comply with.

16. The method of claim 14, wherein the rest bidding time ratio is the ratio of the rest bidding time to the whole bidding time.

17. The method of claim 14, wherein the weighted analysis is performed by providing different statistical weights according to the rest bidding time ratio to compute a match probability.

18. The method of claim 14, wherein the match analysis includes at least a possible matching price and a matching probability.

19. The method of claim 14, wherein the step of adjusting the bidding information further comprising the following steps when no match is reached:
storing the bidding information to a bidding history record;
appending the bidding information to the effective case records; and
ending the bidding procedure.

20. The method of claim 14 further comprising the following steps when the buy-it-now condition is reached:
updating the effective case records, the bidding history, and the deal history;
generating and giving a credit evaluation to the user; and
sending out a case matching message, completing the match and ending the matching procedure.

21. The method of claim 20, wherein the step of when the buy-it-now condition is reached refers to the situation when the current bid price/bid-winning price entered by the bidder matches with the buy-it-now price set by the seller.

22. The method of claim 9 further comprising the setup procedure including the steps of:
displaying a case posting screen and receiving the case information from the seller;
reading the case information and extracting the deal history records to display;
displaying a match setting screen and receiving the match condition from the seller;
storing case contents in the effective case records; and
finishing the setup procedure.
